(19) United States
(12) Patent Application Publication
(10) Pub. No.: US 2024/0329306 A1
(43) Pub. Date: Oct. 3, 2024

(54) OPTICAL DEVICE

(71) Applicant: TDK CORPORATION, Tokyo (JP)

(72) Inventors: Shuntaro KODAMA, Hong Kong (CN); Hiroshi TAKE, Hong Kong (CN); Kenji NAGASE, Hong Kong (CN); Ryohei FUKUZAKI, Hong Kong (CN)

(73) Assignee: TDK CORPORATION, Tokyo (JP)

(21) Appl. No.: 18/620,035

(22) Filed: Mar. 28, 2024

(30) Foreign Application Priority Data
Mar. 30, 2023 (CN) 202310331665.X

(51) Int. Cl. G02B 6/122; G02B 6/12

(52) U.S. Cl. CPC G02B 6/122; G02B 2006/12097

(57) ABSTRACT

An optical device includes: a substrate having a pair of main surfaces opposite each other in a first direction and an end surface adjacent to the main surface, and an optical waveguide formed on the substrate and having a light incident surface or a light exit surface in a direction of a plane where the end surface is located, where at least a central portion of the light incident surface and/or light exit surface of the optical waveguide includes an inclined surface having a preset angle with respect to the end surface of the substrate.

### FIELD OF THE INVENTION

The present invention relates to an optical device.

### BACKGROUND OF THE INVENTION

In recent years, with the popularity of fiber optic transmission, the technologies of integrating multiple optical elements with a high density are required. A quartz-based Planar Lightwave Circuit (hereinafter also referred to as PLC) is known as one of the technologies. The quartz-based PLC has excellent characteristics such as a low loss, high reliability, and a high degree of design freedom, and is expected to be a platform with integrated composite functions.

In practice, light receiving apparatuses in a transmit end station, an optical module composed of a light receiving element such as a photodiode (hereinafter also referred to as PD), or a light emitting element such as a laser diode (hereinafter also referred to as LD), for example an RGB optical semiconductor element is mounted by optical coupling with a PLC provided with functional elements such as a duplexer, a branch coupler, and an optical modulator. Moreover, for example, a plurality of LDs and PDs are integrally mounted in a node apparatus of a wavelength division multiplexing transmission mode to monitor the light intensity of a plurality of optical waveguides in the PLC.

A bond of LD and PLC has a great demand for low loss and low power consumption from the perspective of energy saving (input current and heat generation) in terms of Automatic Power Control (APC), and maximum suppression of an optical coupling loss is required.

However, in the conventional PLC, the end portion of the optical waveguide is flush with the end portion of the substrate, whereby a portion of the light is likely to be reflected at a bond interface, and multiple reflections and returned light may damage the LD, resulting an optical coupling loss.

### CITATION LIST

### Patent Document

Patent Document 1: JP 2015-197616

### SUMMARY OF THE INVENTION

The present invention is implemented in light of the above problem, and is intended to provide an optical device capable of reducing an amount of light reflection attenuation and thereby reducing an optical coupling loss.

An embodiment of the present invention provides an optical device, including: a substrate having a pair of main surfaces opposite each other in a first direction and an end surface adjacent to the main surface; and an optical waveguide formed on the substrate and having a light incident surface or a light exit surface in a direction of a plane where the end surface is located, wherein, at least a central portion of the light incident surface and/or light exit surface of the optical waveguide comprises an inclined surface having a preset angle with respect to the end surface of the substrate.

According to the optical device of the present invention, at least the central portion of the light incident surface and/or light exit surface of the optical waveguide includes the inclined surface having the preset angle with respect to the end surface of the substrate, so that an amount of light reflection attenuation can be reduced and thereby an optical coupling loss can be reduced.

Further, in the optical device of the present invention, preferably, the inclined surface is not inclined with respect to the first direction.

Further, in the optical device of the present invention, preferably, the inclined surface is inclined with respect to the first direction.

Further, in the optical device of the present invention, preferably, the inclined surface is a planar surface or a curved surface.

Further, in the optical device of the present invention, preferably, at least a portion of an end portion of the substrate surrounding the optical waveguide and an end portion of the optical waveguide jointly form the inclined surface.

Further, in the optical device of the present invention, preferably, an end portion of the optical waveguide is closer to an inner side than the end portion of the substrate in a view from the first direction.

Further, the optical device of the present invention preferably further comprises: a protective layer which is formed adjacent to the optical waveguide, wherein, at least a portion of an end portion of the protective layer surrounding the optical waveguide and an end portion of the optical waveguide jointly form the inclined surface.

Further, in the optical device of the present invention, preferably, an end portion of the protective layer is closer to an inner side than an end portion of the substrate in the view from the first direction.

Further, in the optical device of the present invention, preferably, the optical waveguide includes a slab portion and a ridge portion formed on the slab portion; the inclined surface is formed at least on the ridge portion.

Further, in the optical device of the present invention, preferably, the optical waveguide is formed by an electro-optic material film.

### Advantageous Effects of the Invention

The optical device of the present invention is capable of reducing an amount of light reflection attenuation and thereby reducing an optical coupling loss.

### BRIEF DESCRIPTION OF THE DRAWINGS

FIG. 1A and FIG. 1B are perspective views illustrating an optical device according to an embodiment of the present invention, where FIG. 1A is a perspective view illustrating a case in which a light incident surface of an optical waveguide has an inclined surface A, and FIG. 1B is a perspective view illustrating a case in which the light incident surface of the optical waveguide has an inclined surface B.

FIG. 2A is a top view illustrating a case in which a light incident surface of an optical waveguide has an inclined surface A, and FIG. 2B is a side view illustrating a case in which the light incident surface of the optical waveguide has an inclined surface B.

FIG. 3A is a top view illustrating a case in which at least a portion of an end portion of a substrate surrounding an optical waveguide and an end portion of the optical waveguide jointly form an inclined surface A, and FIG. 3B is a side view illustrating a case in which at least a portion of the end portion of the substrate surrounding the optical waveguide and the end portion of the optical waveguide jointly form an inclined surface B.

FIG. 4 is an X-Z cross-sectional view illustrating a case in which a protective layer is formed on an optical device according to an embodiment of the present invention.

FIG. 5A is a perspective view illustrating a case in which at least a portion of an end portion of a protective layer surrounding an optical waveguide and an end portion of the optical waveguide jointly form an inclined surface A, and FIG. 5B is a Y-Z cross-sectional view illustrating a case in which at least a portion of the end portion of the protective layer surrounding the optical waveguide and the end portion of the optical waveguide jointly form an inclined surface B.

FIG. 6 is an X-Z cross-sectional view illustrating a case in which an optical waveguide of an optical device according to an embodiment of the present invention includes a slab portion and a ridge portion.

### DETAILED DESCRIPTION

A manner for implementing the present invention is described below in detail with reference to the drawings. To facilitate an understanding of features of the present invention, portions of the drawings used in the following description that serve as features are sometimes enlarged for convenience, and size ratios, etc., of the constituent elements are sometimes different from those used in practice. The materials, dimensions, etc. illustrated in the following description are examples, which are not intended to limit the present invention, and can be implemented with appropriate changes within the scope of realizing the effects of the present invention. In addition, in the description of the drawings, same or equivalent elements are indicated by the same symbols, and repeated descriptions are omitted.

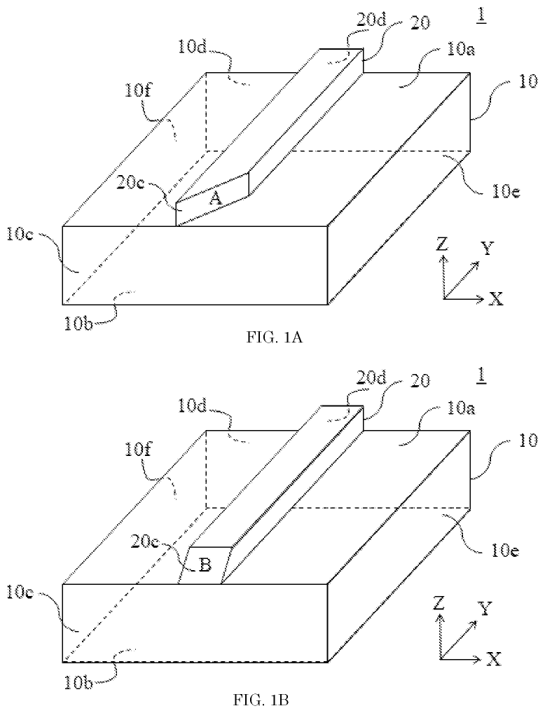

FIG. 1A and FIG. 1B are perspective views illustrating an optical device according to an embodiment of the present invention, where FIG. 1A is a perspective view illustrating a case in which a light incident surface of an optical waveguide has an inclined surface A, and FIG. 1B is a perspective view illustrating a case in which the light incident surface of the optical waveguide has an inclined surface B.

The optical device 1 of a first embodiment of the present invention includes a substrate 10, and an optical waveguide 20 formed on the substrate 10, wherein, a light incident surface 20c and/or light exit surface 20d of the optical waveguide 20 include an inclined surface. The optical device 1 may be, for example, a planar lightwave circuit (PLC) used for receiving light signals from light emitting elements such as a laser diode (LD). Each constituent element is described below in detail.

### (Substrate)

The substrate 10 has a substantially cuboid shape. The cuboid shape includes a cuboid shape with a chamfered corner and a chamfered edge, and a cuboid shape with a filleted corner and a filleted edge. The substrate 10 has a pair of main surfaces 10a and 10b opposite each other, a pair of end surfaces 10c and 10d opposite each other, and a pair of side surfaces 10e and 10f opposite each other. A direction in which the pair of main surfaces 10a and 10b are opposite each other is a first direction D1 (Z direction). A direction in which the pair of end surfaces 10c and 10d are opposite each other is a second direction D2 (Y direction). A direction in which the pair of side surfaces 10e and 10f are opposite each other is a third direction D3 (X direction). In this embodiment, the first direction D1 is a height direction of the substrate 10. The second direction D2 is a long side direction of the substrate 10, which is orthogonal to the first direction D1. The third direction D3 is a width direction of the substrate 10, which is orthogonal to the first direction D1 and the second direction D2.

The pair of end surfaces 10c and 10d extend in the first direction D1 in a manner of connecting the pair of main surfaces 10a and 10b. The pair of end surfaces 10c and 10d also extend in the third direction D3 (a short side direction of the pair of main surfaces 10a and 10b). The pair of end surfaces 10c and 10d are adjacent to the main surface 10a. The pair of side surfaces 10e and 10f extend in the first direction D1 in a manner of connecting the pair of main surfaces 10a and 10b. The pair of side surfaces 10e and 10f also extend in the second direction D2 (a long side direction of the pair of main surfaces 10a and 10b).

The substrate 10 is not particularly limited as long as it has a lower refractive index than the lithium niobate, but it is preferable a substrate on which a lithium niobate film can be formed as an epitaxial film, and a sapphire single crystal substrate or a silicon single crystal substrate is preferable. The crystal orientation of the single crystal substrate is not particularly limited. The lithium niobate film has properties such as being easily formed as a c-axis-oriented epitaxial film with respect to single crystal substrates of various crystal orientations. Since the c-axis oriented lithium niobate film has three-fold symmetry, it is desirable that the underlying single crystal substrate also has the same symmetry. In the case of a sapphire single crystal substrate, a c-plane substrate is preferred, and in the case of a silicon single crystal substrate, a (111) plane substrate is preferred.

### (Optical Waveguide)

As shown in FIG. 1A and FIG. 1B, the optical waveguide 20 is disposed along the main surface 10a of the substrate 10 in a manner extending along an XY plane. In the figure, the optical waveguide 20 extends in the second direction D2, and a light transmission direction in the optical waveguide 20 is the same as the second direction D2. However, the optical waveguide 20 may also be disposed in an inclined or meandering manner on the main surface of the substrate 10 as needed. The optical waveguide 20 has the light incident surface 20c and/or the light exit surface 20d in directions of a plane where the end surfaces 10c and 10d of the substrate 10 are located. In this embodiment, the optical waveguide 20 has the light incident surface 20c at a side of the end surface 10c of the substrate 10, and the light exit surface 20d at a side of the end surface 10d. A shape of the optical waveguide 20 having the light incident surface 20c at the side of the end surface 10c of the substrate 10 is illustrated below as an example. It should be understood that the light exit surface 20d may have the same shape as the 1 light incident surface 20c. The light incident surface 20c receives, for example, a light signal from the LD.

Since the optical waveguide 20 is not particularly limited as long as it is made of an electro-optic material, the film forming the optical waveguide 20 may be called an electro-optic material film. However, the optical waveguide 20 is preferably composed of lithium niobate (LiNbO₃). This is because lithium niobate has a large electro-optic constant and is suitable as a constituent material of optical devices such as optical modulators. The optical waveguide 20 may also be composed of lithium tantalate (LiTaO₃). In addition, when the optical waveguide 20 is composed of lithium niobate, other elements may also be doped, for example, lithium niobate may be doped with at least one selected from Ti, Mg, Zn, In, Sc, Er, Tm, Yb, and Lu.

The thickness of the lithium niobate film is preferably 2 μm or less, and it is preferably 1.2 μm. This is because if the film thickness is thicker than 2 μm, it is difficult to form a film with high quality. On the other hand, while the film thickness of the lithium niobate film is too thin, the restriction of light in the lithium niobate film becomes weaker and light may leak to the substrate 10. Even if an electric field is applied to the lithium niobate film, there is a concern that the change in the effective refractive index of the optical waveguide 20 becomes smaller. Therefore, the lithium niobate film preferably has a film thickness of about 1/10 or more of the wavelength of the used light. Furthermore, the width of the lithium niobate film may be, for example, 1 μm.

It is desirable to form the lithium niobate film by a film forming method such as sputtering, CVD or sol-gel process. Application of an electric field along the c-axis perpendicular to the main surface of the single-crystal substrate can change the optical refractive index in proportion to the electric field. In the case of the single-crystal substrate made of sapphire, the lithium niobate film can be directly epitaxially grown on the single-crystal sapphire substrate. In the case of the single-crystal substrate made of silicon, the lithium niobate film is epitaxially grown on a clad layer (not shown). The clad layer (not shown) has a lower refractive index than the lithium niobate film and should be suitable for epitaxial growth. For example, a high-quality lithium niobate film can be formed on a clad layer (not shown) made of Y₂O₃.

Here, the epitaxial film is a film oriented in alignment with the crystal orientation of the underlying substrate or underlying film. When the film plane is defined as the XY plane and the film thickness direction is defined as the Z axis, the crystals are aligned and oriented along the X, Y and Z axes. For example, the epitaxial film can be verified by first confirming the intensity at the orientation position by 2θ-θ X-ray diffraction and secondly confirming the pole.

Specifically, first, when measurement is performed by 2θ-θ X-ray diffraction, the peak intensity of all peaks other than the target surface is 10% or less, preferably 5% or less, of the maximum peak intensity of the target surface. For example, in a c-axis oriented epitaxial film of lithium niobate, the peak intensity of planes other than the (00L) plane is 10% or less, preferably 5% or less of the maximum peak intensity of the (00L) plane. (00L) is a generic term for equivalent planes such as (001) and (002).

Secondly, poles must be observed in the measurement. Under the condition where the peak intensities are measured at the first orientation position, only the orientation in a single direction is proved. Even if the first condition is satisfied, in the case of nonuniformity in the in-plane crystalline orientation, the X-ray intensity is not increased at a particular angle, and poles cannot be observed. Since LiNbO₃ has a trigonal crystal system, single-crystal LiNbO₃ (014) has 3 poles. For the lithium niobate film, it is known that crystals rotated by 180° about the c-axis are epitaxially grown in a symmetrically-coupled twin crystal state. In this case, three poles are symmetrically-coupled to form six poles. When the lithium niobate film is formed on a single-crystal silicon substrate having a (100) plane, the substrate has four-fold symmetry, and 4×3=12 poles are observed. In the present invention, the lithium niobate film epitaxially grown in the twin crystal state is also considered to be an epitaxial film.

### (Inclined Surface)

In order to realize an optical waveguide with a small amount of reflection attenuation, the light incident surface 20c and/or the light exit surface 20d of the optical waveguide 20 preferably include an inclined surface inclined with respect to the end surface 10c and/or the end surface 10d of the substrate 10. The optical waveguide 20 having the light incident surface 20c at the side of the end surface 10c of the substrate 10 is illustrated below as an example.

Specifically, at least a central portion of the light incident surface 20c of the optical waveguide 20 includes the inclined surface with a preset angle with respect to the end surface 10c of the substrate 10. In a view from the first direction D1, the end portion of the optical waveguide 20 is closer to an inner side than the end portion of the substrate 10.

The inclined surface is disposed to reduce the amount of light reflection attenuation and thus reduce a light coupling loss. In the case of optical device coupling, reflection attenuation occurs when light is coupled from one optical device or medium to another optical device or medium. When light is incident in a form approximately perpendicular to an interface, part of the light is reflected. By setting the interface as being inclined, although light passing through the interface and reflected light are both reduced, the reflected light is reduced by a larger amount, thereby effectively reducing the amount of reflection attenuation and thus reducing the light coupling loss. In the embodiment of the present invention, the light coupling loss can be effectively suppressed by causing the light incident surface 20c of the optical waveguide 20 to include the inclined surface. Moreover, the light incident surface 20c can be properly coated with an anti-reflection film.

Thus, an orientation of the inclined surface is not defined, as long as it is inclined with respect to the end surface 10c of the substrate 10. For example, the inclined surface may be an inclined surface (hereinafter referred to as the inclined surface A) disposed as being not inclined with respect to the first direction D1 as shown in FIG. 1A, or an inclined surface (hereinafter referred to as the inclined surface B) disposed as being inclined with respect to the first direction D1 as shown in FIG. 1B.

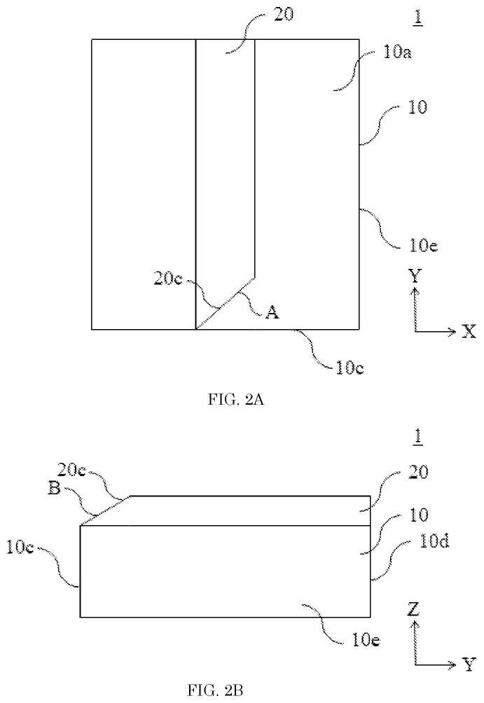

FIG. 1A is a perspective view illustrating a case in which the light incident surface of the optical waveguide has the inclined surface A, and FIG. 1B is a perspective view illustrating a case in which the light incident surface of the optical waveguide has the inclined surface B. FIG. 2A is a top view illustrating a case in which the light incident surface of the optical waveguide has the inclined surface A, and FIG. 2B is a side view illustrating a case in which the light incident surface of the optical waveguide has the inclined surface B.

It should be noted that the angle of the inclined surface with respect to the end surface of the substrate enlarged in the drawings for ease of illustration. In practice, the angle may be any angle as long as it can achieve the effect of reducing the amount of light reflection attenuation and thereby reducing the light coupling loss. For example, the angle of inclination of the inclined surface with respect to the end surface 10c of the substrate 10 is set to be greater than 0°, preferably 5°-10°.

In FIGS. 1A, 1B and 2, only the case in which the inclined surface is a planar surface is shown. The inclined surface, however, may also be a curved surface. For example, the inclined surface may be a curved surface that is convex toward the end surface 10c of the substrate 10, or a curved surface that is concave toward the end surface 10d of the substrate 10. The shape of the inclined surface may be any shape, as long as it can achieve the effect of reducing the amount of light reflection attenuation and thereby reducing the light coupling loss. In addition, the inclined surface can achieve the effect of reducing the amount of light reflection attenuation and thereby reducing the light coupling loss, as long as the it is disposed at a position (e.g., the central portion of the optical waveguide) where the light mainly propagates, without forming the inclined surface on the entire section of the optical waveguide.

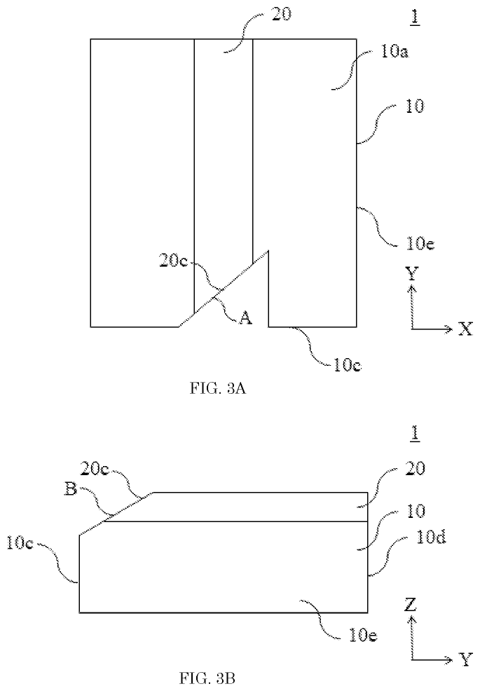

Furthermore, FIG. 3A is a top view illustrating a case in which at least a portion of the end portion of the substrate surrounding the optical waveguide and the end portion of the optical waveguide jointly form the inclined surface A, and FIG. 3B is a side view illustrating a case in which at least a portion of the end portion of the substrate surrounding the optical waveguide and the end portion of the optical waveguide jointly form the inclined surface B.

As shown in FIG. 3A and FIG. 3B, the inclined surface is jointly composed of at least a portion of the end portion at the side of the end surface 10c of the substrate 10 surrounding the optical waveguide 20 and the end portion of the light incident surface 20c of the optical waveguide 20. In other words, the inclined surface may be formed not only by the end portion of the light incident surface 20c of the optical waveguide 20, but may also be jointly formed by a portion of the end portion at the side of the end surface 10c of the substrate 10 and the end portion of the light incident surface 20c of the optical waveguide 20. For convenience in grinding or cutting the end portion of the optical waveguide 20, sometimes a portion of the end portion at the side of the end surface 10c of the substrate 10 surrounding the optical waveguide 20 is ground or cut together with the end portion of the light incident surface 20c of the optical waveguide 20. As such, at least the portion of the end portion of the substrate 10 surrounding the optical waveguide 20 and the end portion of the optical waveguide 20 jointly form the inclined surface. In the view from the first direction D1, the end portion of the optical waveguide 20 is closer to the inner side than the end portion of the substrate 10. Similarly, the inclined surface having such a structure may achieve the effect of reducing the amount of light reflection attenuation and thereby reducing the light coupling loss.

The inclined surface may be formed using methods such as grinding, polishing, laser cutting, etc. The inclined surface having a preset angle with respect to the end surface 10c of the substrate 10 is formed on the light incident surface 20c and/or the light exit surface 20d of the optical waveguide 20. In the view from the first direction D1, the end portion of the optical waveguide 20 is closer to the inner side than the end portion of the substrate 10. The light incident surface 20c and/or the light exit surface 20d of the optical waveguide 20 may be ground or cut integrally, to form the inclined surface that has a structure as shown in FIG. 2A and FIG. 2B on the end portion of the optical waveguide 20. The light incident surface 20c and/or the light exit surface 20d of the optical waveguide 20 may also be ground or cut partially, to form the inclined surface (not shown) on at least a portion (e.g., the central portion) of the end portion of the optical waveguide 20. The light incident surface 20c and/or the light exit surface 20d of the optical waveguide 20 may also be ground or cut together with a portion of the end surface 10c of the substrate 10 surrounding the optical waveguide 20, to form the inclined surface that has a structure as shown in FIG. 3A and FIG. 3B on the end portion of the optical waveguide 20.

As such, by causing at least the central portion of the light incident surface 20c and/or the light exit surface 20d of the optical waveguide 20 to include the inclined surface having the preset angle with respect to the end surface 10c of the substrate 10, the optical device 1 according to the embodiment of the present invention is capable of reducing the amount of light reflection attenuation and thereby reducing the optical coupling loss.

### (Protective Layer)

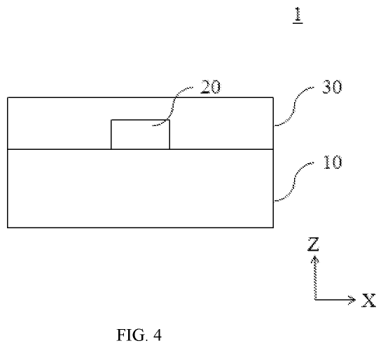

FIG. 4 is an X-Z cross-sectional view illustrating a case in which a protective layer is formed on the optical device according to an implementation of the present invention.

In order to prevent the light propagating in the optical waveguide 20 from being absorbed by the substrate 10 or an external electrode, as shown in FIG. 4, the optical device 1 in this embodiment of the present invention may also be provided with the protective layer 30, which is formed adjacent to the optical waveguide 20. In this embodiment, the protective layer 30 covers not only an upper surface of the optical waveguide 20, but also the substrate 10 where the optical waveguide 20 is not formed, and the side surfaces of the optical waveguide 20 are also covered by the protective layer 30, so that a light propagation loss in the optical waveguide 20 may be reduced.

The material of the protective layer 30 can be widely selected. For example, the protective layer 30 may be made using made of a non-metallic oxide such as silicon oxide, a metal oxide such as aluminum oxide, a metal nitride, a metal carbide, a resin material such as polyimide, or an insulating material such as ceramics. The material of the protective layer may be a crystalline material or an amorphous material. In a more preferred embodiment, a material having a refractive index less than the refractive index of the optical waveguide 20 may be used as the protective layer 30, such as Al₂O₃, SiO₂, LaAlO₃, LaYO₃, ZnO, HfO₂, MgO, and Y₂O₃. The thickness of the protective layer 30 formed on the optical waveguide 20 may be about 0.2˜1.2 μm.

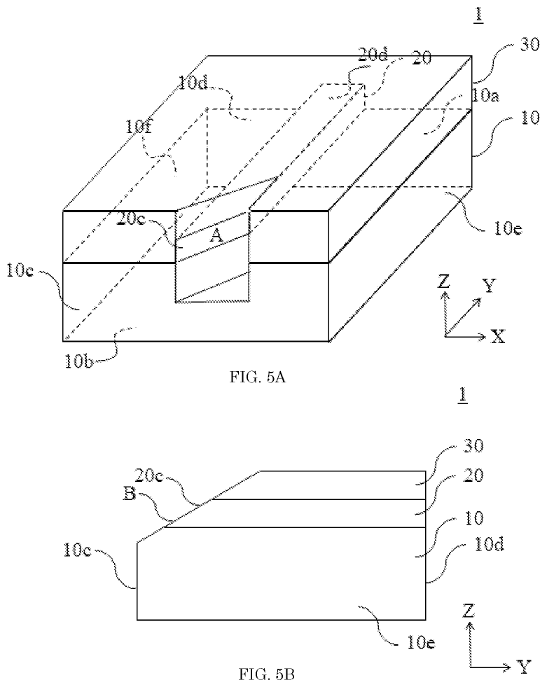

FIG. 5A is a perspective view illustrating a case in which at least a portion of an end portion of the protective layer surrounding the optical waveguide and the end portion of the optical waveguide jointly form the inclined surface A, and FIG. 5B is an Y-Z cross-sectional view illustrating a case in which at least a portion of the end portion of the protective layer surrounding the optical waveguide and the end portion of the optical waveguide jointly form the inclined surface B.

As shown in FIG. 5A and FIG. 5B, the inclined surface is jointly composed of the end portion of the protective layer 30 surrounding the optical waveguide 20 and the end portion of the light incident surface 20c of the optical waveguide 20. Furthermore, the inclined surface is jointly composed of at least a portion of the end portion of the protective layer 30 surrounding the optical waveguide 20, at least a portion of the end portion at the side of the end surface 10c of the substrate 10 surrounding the optical waveguide 20 and the end portion of the light incident surface 20c of the optical waveguide 20. In other words, the inclined surface may be formed not only by the end portion of the light incident surface 20c of the optical waveguide 20, but may also be jointly formed by the end portion of the protective layer 30 and/or the end portion at the side of the end surface 10c of the substrate 10 and the end portion of the light incident surface 20c of the optical waveguide 20. For the convenience in grinding or cutting the end portion of the optical waveguide 20, sometimes a portion of the end portion of the protective layer 30 surrounding the optical waveguide 20 is ground or cut together with the end portion of the light incident surface 20c of the optical waveguide 20; furthermore, a portion of the end portion of the protective layer 30 and/or a portion of the end portion at the side of the end surface 10c of the substrate 10 surrounding the optical waveguide 20 are ground or cut together with the end portion of the light incident surface 20c of the optical waveguide 20. As such, at least the portion of the end portion of the protective layer 30 surrounding the optical waveguide 20 and the end portion of the optical waveguide 20 jointly form the inclined surface; furthermore, at least the portion of the end portion of the protective layer 30 and/or at least the portion of the end portion at the side of the end surface 10c of the substrate 10 surrounding the optical waveguide 20, and the end portion of the optical waveguide 20 jointly form the inclined surface. In the view from the first direction D1, both the end portion of the optical waveguide 20 and the end portion of the protective layer 30 are closer to the inner side than the end portion of the substrate 10. Similarly, the inclined surface having such a structure may achieve the effect of reducing the amount of light reflection attenuation and thereby reducing the light coupling loss.

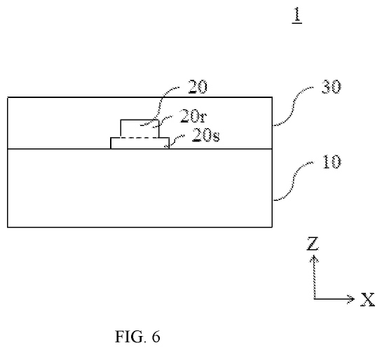

FIG. 6 is an X-Z cross-sectional view illustrating a case in which the optical waveguide of the optical device according to an embodiment of the present invention includes a slab portion and a ridge portion.

As shown in FIG. 6, the optical waveguide 20 is composed of the slab portion 20s and the ridge portion 20r protruding from the slab portion 20s. The slab portion 20s is formed on the substrate 10 in a thin form and may be formed, for example, in the shape of a layer or a slab, but not limited to this, and may also be a slightly inclined layer, such as a trapezoidal shape. The ridge portion 20r protrudes from the slab portion 20s, and may for example, protrude upward from the slab portion 20s by a certain height in a columnar shape. However, the shape of the ridge portion 20r is not limited hereby, and may also protrude in a cone shape only, or may further protrude in a plurality of stages. The inclined surface is formed at least on the ridge portion 20r of the optical waveguide 20.

Since light propagates mainly within the ridge portion 20r of the optical waveguide 20, causing the ridge portion 20r of the light incident surface 20c to include the inclined surface having the preset angle with respect to the end surface 10c of the substrate 10 likewise can reduce the amount of light reflection attenuation and thus reduce the light coupling loss.

### EXAMPLE

Examples 1 and 2 were made according to the optical device 1 shown in FIG. 2A. In Example 1, the light incident surface 20c of the optical waveguide 20 has the inclined surface A with respect to the end surface 10c of the substrate 10, and the angle formed by the inclined surface A with respect to the end surface 10c is approximately 10°. In Example 2, a structure is identical to that of Example 1 except that the angle formed by the inclined surface A with respect to the end surface 10c is approximately 5°. Furthermore, Comparative example 1 were made based on an optical device having the same structure as the optical device 1 shown in FIG. 2A but not having inclined surface (i.e., the light incident surface 20c of the optical waveguide 20 is flush with the end surface 10c of the substrate 10) on the light incident surface 20c of the optical waveguide 20. Considering deviations in production, Comparative examples 1˜3 with identical structures were made respectively. The light coupling loss of each of the Examples and Comparative examples was measured respectively. The results are shown in Table 1.

As can be seen from Table 1, the light coupling loss (8.1 to 8.7 db) of the case when the light incident surface 20c of the optical waveguide 20 has the inclined surface with respect to the end surface 10c of the substrate 10 is less than the light coupling loss (8.8 to 9.4 db) of the case when the light incident surface 20c of the optical waveguide 20 has no inclined surface with respect to the end surface 10c of the substrate 10. Therefore, forming the inclined surface having an angle with respect to the end surface 10c of the substrate 10 can reduce the amount of light reflection attenuation effectively and thereby reduce the light coupling loss.

TABLE 1

| | | Angle of the light | |
|---|---|---|---|
| | | incident surface with | |
| | Whether the light | respect to the end | Light |
| | incident surface has | surface of the | coupling |
| | an inclined surface | substrate (°) | loss (db) |
| Example 1 | Yes | 10° | 8.1 |
| Example 2 | Yes | 5° | 8.7 |
| Comparative | No | — | 8.8 |
| example 1 | | | |
| Comparative | No | — | 9.0 |
| example 2 | | | |
| Comparative | No | — | 9.4 |
| example 3 | | | |

Although the present invention is described in detail above in conjunction with the drawings and examples, it may be understood that the above description does not limit the present invention in any form. For example, the above optical device 1 is illustrated by forming the optical waveguide 20 along the substrate 10, but is not limited hereby, and there may be more than one optical waveguide. When the optical device 1 is provided with a plurality of optical waveguides, the inclined surface needs to be provided on only the light incident surface and/or the light exit surface of the at least one optical waveguide.

In addition, in the above embodiments, the optical waveguide 20 has the light incident surface 20c at the side of the end surface 10c of the substrate 10, while the optical waveguide 20 may also have the light exit surface 20d at the side of the end surface 10c of the substrate 10. Similarly, the optical waveguide 20 may have the light incident surface 20c at the side of the end surface 10d of the substrate 10, while the optical waveguide 20 may also have the light exit surface 20d at the side of the end surface 10d of the substrate 10.

In addition, in the above embodiments, two patterns in which the inclined surface is the inclined surface A and the inclined surface B are recited above as examples. However, the inclined surface is not limited hereby, and may also be in other forms, for example, a three-dimensional structure combining the inclined surface A and the inclined surface B, such as a spherical surface, a conical surface, etc.

A person skilled in the art could make modifications and changes to the present invention as needed, without deviating from the spirit and scope of the present invention, and these modifications and changes all fall within the scope of the present invention.

### REFERENCE NUMERAL

1 optical device
10 substrate
10a, 10b main surface
10c, 10d end surface
10e, 10f side surface
20 optical waveguide
20c light incident surface
20d light exit surface
20s slab portion
20r ridge portion
30 protective layer
A, B inclined surface
D1 first direction (Z direction)
D2 second direction (Y direction)
D3 third direction (X direction)

1-10. (canceled)

11. An optical device comprising:
a substrate having a pair of main surfaces opposite each other in a first direction and an end surface adjacent to the main surface, and
an optical waveguide formed on the substrate and having a light incident surface or a light exit surface in a direction of a plane where the end surface is located, wherein,
at least a central portion of the light incident surface and/or light exit surface of the optical waveguide comprises an inclined surface having a preset angle with respect to the end surface of the substrate.

12. The optical device according to claim 11, wherein,
the inclined surface is not inclined with respect to the first direction.

13. The optical device according to claim 11, wherein,
the inclined surface is inclined with respect to the first direction.

14. The optical device according to claim 11, wherein,
the inclined surface is a planar surface or a curved surface.

15. The optical device according to claim 11, wherein,
at least a portion of an end portion of the substrate surrounding the optical waveguide and an end portion of the optical waveguide jointly form the inclined surface.

16. The optical device according to claim 11, wherein,
an end portion of the optical waveguide is closer to an inner side than the end portion of the substrate in a view from the first direction.

17. The optical device according to claim 11, further comprising:
a protective layer which is formed adjacent to the optical waveguide, wherein,
at least a portion of an end portion of the protective layer surrounding the optical waveguide and an end portion of the optical waveguide jointly form the inclined surface.

18. The optical device according to claim 17, wherein,
an end portion of the protective layer is closer to an inner side than an end portion of the substrate in the view from the first direction.

19. The optical device according to claim 11, wherein,
the optical waveguide comprises a slab portion and a ridge portion formed on the slab portion;
the inclined surface is formed at least on the ridge portion.

20. The optical device according to claim 11, wherein,
the optical waveguide is formed by an electro-optic material film.
